(19) United States
(12) Patent Application Publication
(10) Pub. No.: US 2024/0141693 A1
(43) Pub. Date: May 2, 2024

(54) ELECTRONICALLY CONTROLLED MECHANICAL LOCK SYSTEM FOR A ROLL-UP DOOR AND METHODS OF USING THE SAME

(71) Applicant: Synergy Product Solutions Inc., Warren, OH (US)

(72) Inventors: James B. Brown, Crystal Lake, IL (US); Mark Schroeder, Findlay, OH (US)

(21) Appl. No.: 18/208,873

(22) Filed: Jun. 12, 2023

Related U.S. Application Data
(60) Provisional application No. 63/362,772, filed on Apr. 11, 2022.

(51) Int. Cl. E05B 47/00; E05C 9/04

(52) U.S. Cl. CPC E05B 47/0004; E05C 9/048; E05B 2047/0016

(57) ABSTRACT

An electronically controlled mechanical lock system for a roll-up door, such as for a vehicle or a garage door generally having horizontally disposed panels and tracks on opposite sides thereof for moving rollers therein. Methods of using the same are further provided.

The present invention claims priority to U.S. Prov. Pat. App. No. 63/362,772, titled “Electronic Lock System for Roll Up Door,” filed Apr. 11, 2022, which is incorporated herein by reference in its entirety.

### TECHNICAL FIELD

An electronic lock system is provided for a roll-up door, such as for a vehicle or a garage door generally having horizontally disposed panels and tracks on opposite sides thereof for moving rollers therein. Methods of using the same are further provided.

### BACKGROUND

Roll-up type doors, such as those used in garages and vehicles, are known, of course. These doors typically comprise a number of hinged panels with rollers on their outer edges. The rollers move within a roller channel framework to selectively move the door from a raised position to a lowered position and vice versa. In some cases, a biasing member, such as a coil spring, may be attached to the door to provide a spring assist when moving the door, which may be heavy.

In some cases, when the door is in the lowered position, a spring-loaded latch mounted on the door selectively engages a stationary ramp bracket located on the framework. The latch engages the ramp to lock the door. A handle can selectively move the latch out of engagement with the ramp so the door may be moved.

Therefore, it may be appreciated that an operator must be in close proximity to the handle to unlock and/or operate the door. Further it may be appreciated that the operator must have one or both hands free to operate the door.

These conditions may be disadvantageous. There may be instances when the operator would prefer to open the door without being in close proximity to the door handle. In some cases, operators, such as delivery drivers, must move quickly when delivering items to maintain their delivery schedules. It is typically difficult to ensure rapid delivery when a driver must manually operate a vehicle door to gain access thereto or wait for a door to open.

A need, therefore, exists for an improved electronic lock system for roll-up doors. Specifically, a need exists for an improved electronic lock system for roll-up doors that would have the door open, or have it opening, as the driver approaches the roll-up door of the vehicle. Moreover, a need exists for an improved electronic lock system for roll-up doors that may automatically open or be manually opened by an operator remotely.

In some cases, operators, such as delivery drivers, may have one or both hands full when approaching a vehicle to open the roll-up door. It may be difficult and time-consuming for these operators to have to come within hand-reach of the door handle, only to have to empty their hands before they can operate the door handle.

A need therefore exists for an improved electronic lock system for roll-up doors that would be openable without the operator needing to come in physical contact with the door. Specifically, a need exists for an improved electronic lock system for roll-up doors that allows an operator to efficiently open the door without having to empty his or her hands. Moreover, a need exists for an improved electronic lock system for roll-up doors that may be opened via an electrical signal.

### SUMMARY OF THE INVENTION

An electronic lock system is provided for a roll-up door, such as for a vehicle or a garage door generally having horizontally disposed panels and tracks on opposite sides thereof for moving rollers therein. Methods of using the same are further provided.

To this end, in an embodiment of the present invention, a roll-up door locking system is provided. The roll-up door locking system comprises: a roll-up door configured to slide on a pair of tracks on opposite sides of the roll-up door between an open configuration and a closed configuration; an actuator mounted adjacent at least one of the tracks, wherein the actuator comprises a piston having a contacting block on an end thereof, wherein the piston moves via the actuator between an extended position and a retracted position; and an engagement element extending from the door, wherein the engagement element is configured to contact the ramp on the piston of the actuator.

In an embodiment, the roll-up door slides on the pair of tracks via a plurality of rollers extending from the door and engaging the pair of tracks.

In an embodiment, the actuator is an electrically controlled solenoid.

In an embodiment, the actuator is controlled via a wireless signal.

In an embodiment, the actuator selectively moves the contacting block when the actuator moves the piston between an extended position and a retracted position, wherein when the actuator is in the extended position, the contacting block is configured to contact the engagement element when the roll-up door is in the closed configuration.

In an embodiment, when the actuator is in the retracted position, the contacting block is configured to be disengaged from the engagement element, allowing the roll-up door to move from the closed configuration to the open configuration.

In an embodiment, the contacting block is a ramp.

In an embodiment, the ramp has an angled face and a horizontal face, wherein the horizontal face is on an underside of the ramp.

In an embodiment, the horizontal face of the ramp is configured to contact the engagement element and maintain the door in the closed configuration.

In an embodiment, the contacting block is a pin.

In an embodiment, the engagement element is selected from the group of a ramp, a block, and a bracket.

In an embodiment, the engagement element is a ramp having a horizontal face and an angled face, wherein the horizontal face is on an upper side of the ramp.

In an embodiment, the horizontal face of the ramp is configured to contact the contacting block when the door is in the closed configuration.

In an embodiment, the engagement element is movable between an extended position and a retracted position.

In an embodiment, the engagement element is biased toward the extended position.

In an embodiment, the door has a handle and further wherein the handle is configured to move the engagement element between the extended position and the retracted position.

In an embodiment, the actuator is mounted to a surface that is coplanar with the roll-up door when the roll-up door is in the closed configuration.

In an embodiment, the actuator is mounted to a surface that is orthogonal to the roll-up door when the roll-up door is in the closed configuration.

In an embodiment, the contacting block is formed from a plurality of linkages that are hinged together wherein extending the piston via the actuator forms a protruding configuration and further wherein retracting the piston via the actuator transforms the contacting block into a flat configuration.

In an embodiment, the actuator is mounted to a surface coplanar with the roll-up door and the piston is configured to extend and retract vertically.

It is, therefore, an advantage and objective of the present invention to provide an improved electronic lock system for roll-up doors.

Specifically, it is an advantage and objective of the present invention to provide an improved electronic lock system for roll-up doors that would have the door open, or opening, as the driver approaches the vehicle.

Moreover, it is an advantage and objective of the present invention to provide an improved electronic lock system for roll-up doors that may automatically open or be manually opened by an operator remotely.

In addition, it is an advantage and objective of the present invention to provide an improved electronic lock system for roll-up doors that would be openable without the operator needing to come in physical contact with the door.

Specifically, it is an advantage and objective of the present invention to provide an improved electronic lock system for roll-up doors that allows an operator to efficiently open the door without having to empty his or her hands.

Moreover, it is an advantage and objective of the present invention to provide an improved electronic lock system for roll-up doors that may be opened via an electrical signal.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a roll-up type door system including an electronically controlled mechanical lock in a first, locked condition in an embodiment of the present invention.

FIG. 2 illustrates a close-up view of an electronically controlled mechanical lock in a first, locked condition in an embodiment of the present invention.

FIG. 3 illustrates a close-up view of an electronically controlled mechanical lock in a transition condition in an embodiment of the present invention.

FIG. 4 illustrates a close-up view of an electronically controlled mechanical lock in an alternate transition condition in an embodiment of the present invention.

FIG. 5 illustrates a close-up view of an electronically controlled mechanical lock in a second, released condition in an embodiment of the present invention.

FIG. 6 illustrates an exemplary embodiment of an electronically controlled mechanical lock including components thereof in an embodiment of the present invention.

FIG. 7 illustrates a close-up view of an electronically controlled mechanical lock showing a ramp in an extended configuration in an embodiment of the present invention.

FIG. 8 illustrates a close-up view of an electronically controlled mechanical lock showing a ramp in a collapsed configuration in an embodiment of the present invention.

FIG. 9 illustrates a close-up view of an electronically controlled mechanical lock showing an extendable and retractable pin engaged to a roll-up door in an embodiment of the present invention.

### DETAILED DESCRIPTION OF THE PRESENTLY PREFERRED EMBODIMENTS

An electronic lock system is provided for a roll-up door, such as for a vehicle or a garage door generally having horizontally disposed panels and tracks on opposite sides thereof for moving rollers therein. Methods of using the same are further provided.

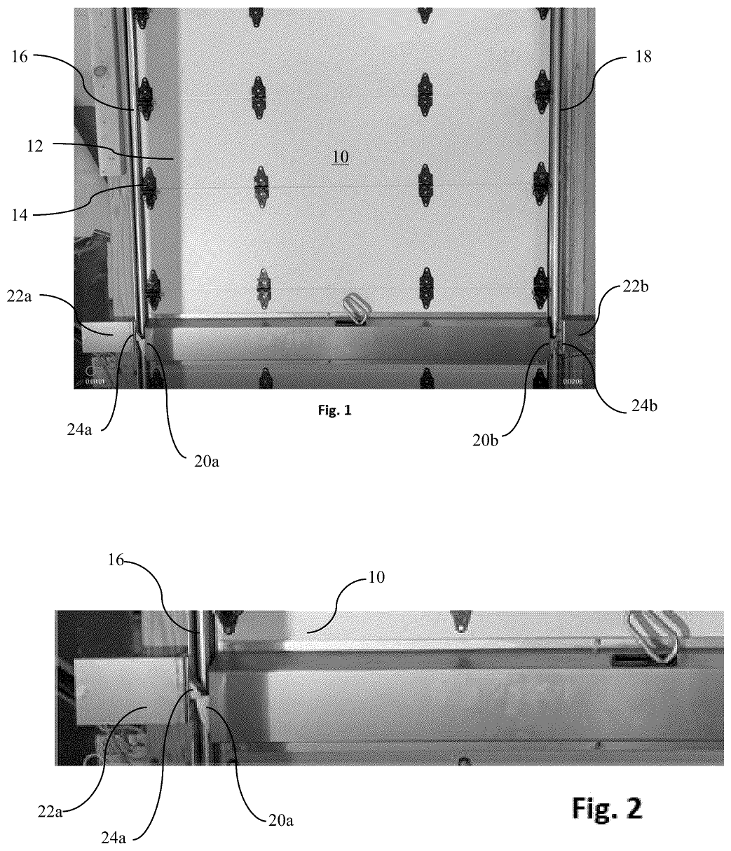

Now referring to the figures, wherein like numerals refer to like parts, FIGS. 1 and 2 illustrate a locking system 1 for a roll-up door 10 in an embodiment of the present invention. The roll-up door 10 is depicted, in FIGS. 1 and 2, from one side, which may be referred to as inner, or indoor, side of the overall system. In other words, the side of the door 10 depicted in FIGS. 1 and 2 may preferably be located inside of a vehicle or located within a garage type setting.

The locking system 1, as described herein, may be adapted for use in both vehicles and/or commercial/residential environments. The locking system 1 is described herein in the context of a vehicle environment for convenience and clarity; however, with little to no changes, the locking system 1 may be readily adapted to other environments as well.

The locking system 1 may comprise a roll-up door 10, as described above. The door may have a plurality of panels 12 where each panel 12 is connected to the adjacent panel or panels by one or more hinges 14. The hinges 14 may permit one panel to selectively become non-planar with the adjacent panel or panels during movement of the door 10. Otherwise, the panels 12 may be generally oriented planar with respect to each other, such as when the door is in a lowered or down position.

The locking system 1 may further be comprised of a first track 16 and a second track 18. The tracks 16, 18 may be generally parallel to one another and may typically be located along the outer lateral edges of the panels 12, or slightly outboard therefrom. The tracks 16, 18 may have a general C-shaped cross-section with the open portion of the Cs facing one another.

The hinges 14, specifically the outermost hinges on the panels 12, may support axles for rollers therein (not shown). The rollers may be wheels mounted for rotation with respect to the stationary axles. The rollers may be captured within the C-shaped tracks 16, 18.

Thus, the plurality of panels 12, which together form the door 10, may collectively move with respect to the stationary tracks 16, 18 through the connection of the rollers within the tracks 16, 18, respectively. Further, the plurality of panels 12 that make up the door 10 may be held securely through the connection of the rollers within the tracks 16, 18, such as when the door is in the lowered position.

In some embodiments, a manual lock engagement device (not shown) may be associated with the system 1. Such devices are generally known and may comprise a mechanism on which an inner handle and outer handle may be mounted. The inner handle may be located and mounted on an inside of the door 10 and the outer handle may be located on the outside of the door 10.

The manual lock engagement mechanism may be connected to door-mounted ramps 20a, 20b, as illustrated in the figures. In one embodiment, the mechanism may be connected to the door-mounted ramps 20a, 20b through cords, wires, chains, bars, or the like. By way of example only, a first cord may be connected to the manual lock engagement mechanism and extend to a first door-mounted ramp 20a. In addition, a second cord may be connected to the manual lock engagement mechanism and extend to a second door mounted ramp 20b.

The ramps 20a, 20b may be wedge-shaped, but may include any shape, and may be located at or adjacent to the outer lateral edges of a panel 12. The ramps may be located coplanar with one another but need not be. The ramps 20a, 20b may be positioned so that they may create a laterally extending uppermost tooth. The tooth may taper laterally inwardly as it extends downwardly so as to create a ramp feature. It should be noted that the ramps 20a, 20b may be any shape and may take the form of a bolt, a block, or other like shape that may engage with ramps 24a, 24b, respectively, as disclosed in more detail below.

The ramps 20a. 20b of the manual lock engagement mechanism may be selectively moved by rotating either the inside or outside handle. Rotating of a handle may pull the first and second cords, which may be attached to the ramps 20a, 20b, as described above. The ramps may be selectively withdrawn laterally inwardly to release them from locking housings 22a, 22b having corresponding locking ramps 24a, 24b, respectively, as described in more detail below.

The housings 22a, 22b may generally include an L-shaped plate having a first leg 26 and a second leg 28, as illustrated in FIG. 6. The first leg 26 may be connected to or adjacent the track 16 (as shown in FIG. 6) but may also be connected in reverse to track 18. The first leg 26 may further extend substantially coplanar, or parallel, with the track 16.

The second leg 28 may extend substantially transverse the first leg 26, but other angles may be permissible. The second leg 28 may extend in the lateral outer direction, such as away, from the door 10.

The first and second legs 26, 28 may preferably be unitary, one-piece, and integrally formed. Alternatively, the first and second legs 26, 28 may be formed from two pieces connected together. The first and second legs 26, 28 may also have substantially constant thickness.

In some embodiments, a biasing member 30 may be located, such as attached, to the housings 22a, 22b. The biasing member 30 may be located so that it extends substantially parallel with the second leg 28.

The biasing member 30 may be an actuator, such as a linear actuator, a solenoid, a pneumatic cylinder and/or a hydraulic cylinder. In one embodiment, the biasing member 30 may be an electrically powered actuator. The actuator may preferably be a linear actuator and may selectively move a piston 32 out of and/or in to the housing 22a, 22b. The movement may be linear, or roughly along a primary axis of the biasing member 30.

In some embodiments, the piston 32 may at least partially and selectively extend through an aperture in the first leg 26 (not shown). In other embodiments, a ramp may be connected to the piston 32 and may at least partially selectively extend through the aperture in the first leg 26.

With continued reference to the ramp embodiment, the ramps 24a, 24b may selectively extend laterally inward toward the door 10. It may be that the ramps 24a, 24b are located so as to selectively engage and disengage with the door-mounted ramps 20a, 20b, respectively. Selective engagement with the door-mounted ramps 20a, 20b may occur when the actuator ramps 24a, 24b are coplanar with the door-mounted ramps 20a, 20b, respectively, such as when the door 10 is in the down or closed position.

The engagement of the door-mounted ramps 20a, 20b with the actuator ramps 24a, 24b, respectively, may be sufficient to lock the door 10 in the down or closed position and may be capable of maintaining that orientation.

The actuator 30 may be activated and/or actuated via an electrical signal. Specifically, by way of example, the signal may be a 12 volt DC type signal from a button, switch, or the like that may be electrically connected to the actuator 30. The button may be located at or adjacent the door 10 or may be located remotely therefrom.

By way of another example, which may be separate or in addition to the embodiment noted above, the actuator 30 may have a receiver (not shown) associated within it. The receiver may be part of the actuator 32 or connected thereto. The receiver may be part of a receiver/transmitter pair. The transmitter of the receiver/transmitter pair may be a radio transmitter that may transmit a radio signal to the receiver. The transmitter may also have a computer chip that develops a unique code that the receiver may use to recognize as coming from the transmitter in use. The transmitter/receiver combination may use passive radio frequency (RFID) technology, Bluetooth technology, Near Field Communication (NFC) technology, or other similar wireless technology, as apparent to one of ordinary skill in the art.

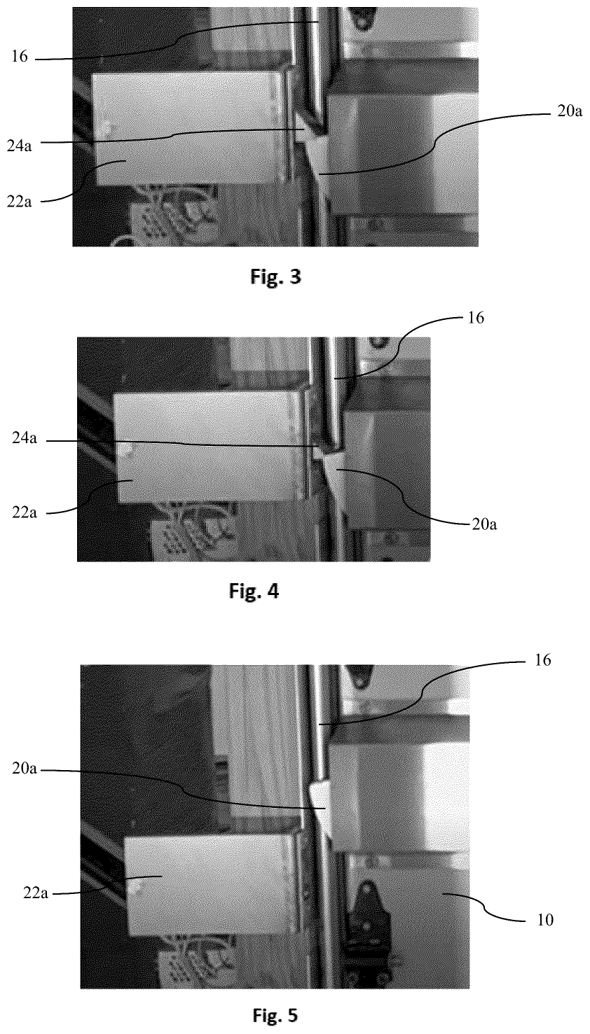

Upon actuation of the transmitter, the receiver may cause the actuator 30 to move the actuator ramp 24a or 24b away from the respective door mounted ramp 20a or 20b. One embodiment of this action is schematically illustrated in FIGS. 3 and 4 illustrating the ramp 24a in transition conditions as the actuator moves the ramp 24a. In such a case, the door-mounted ramp 20a may be laterally fixed instead of connected to inside and/or outside handles, as described above. Alternatively, the door-mounted ramp 20a (and by extension door-mounted ramp 20b) may be spring-biased.

When the actuator ramps 24a, 24b have cleared respective door-mounted ramps 20a, 20b, the door 10 may move along the tracks 16, 18, as illustrated in FIG. 5. Preferably, the door 10 may also be spring-biased to move upwardly along the tracks so that the when the door 10 is unlocked, as described above, it may automatically fully open or at least partially open without any external force except from the spring.

When an operator wishes to engage the door 10 in the closed position by lowering the door 10 along the tracks 16, 18 until the door mounted ramps 20a, 20b and the actuator ramps 24a, 24b, respectively, are again coplanar with one another. The actuator 30 may be engaged such that it moves the piston 32, which may move the actuator ramps 24a, 24b laterally toward the door-mounted ramps 20a, 20b, respectively, until the two ramps contact one another.

In another example, when the door 10 is lowered, the door-mounted ramps 20a, 20b may be spring-loaded to bias the ramps toward the tracks 16, 18 until the door-mounted ramps 20a, 20b contact the actuator ramps 24a, 24b, respectively. As the door 10 descends, the actuator ramps 20a, 20b may push against the spring of the door-mounted ramps 20a, 20b thereby moving the door-mounted ramps 20a, 20b away from the tracks 16, 18 until they have cleared the actuator ramps 24a, 24b, respectively, whereupon the spring will cause them to extend suddenly toward the tracks 16, 18, respectively, and the respective door-mounted ramps 20a, 20b will contact the underside of the actuator ramps 24a, 24b, thereby locking the door-mounted ramps 20a, 20b and, thus, the door 10 in the closed position.

As a safety feature, the piston 32 may be separable from respective actuator ramps 24a, 24b. Specifically, the piston 32 may be held in place to the actuator ramps 24a, 24b, respectively, with a pin or other element that allows the piston 32 and the ramps 24a, 24b to be separable from each other. For example, the pin may extend through an aperture within the ramp 24a and, in turn, within an aperture within the piston 32 and hold the piston 32 to the ramp 24a when in use. Therefore, if there is an issue with the movement of the ramp 24a due to a mechanical or electrical failure, then the pin may be manually pulled and the ramps 24a and/or 24b and separated from the piston 32. Thus, the ramps 24a, 24b may be manually moved or removed so that the door 10 may be opened.

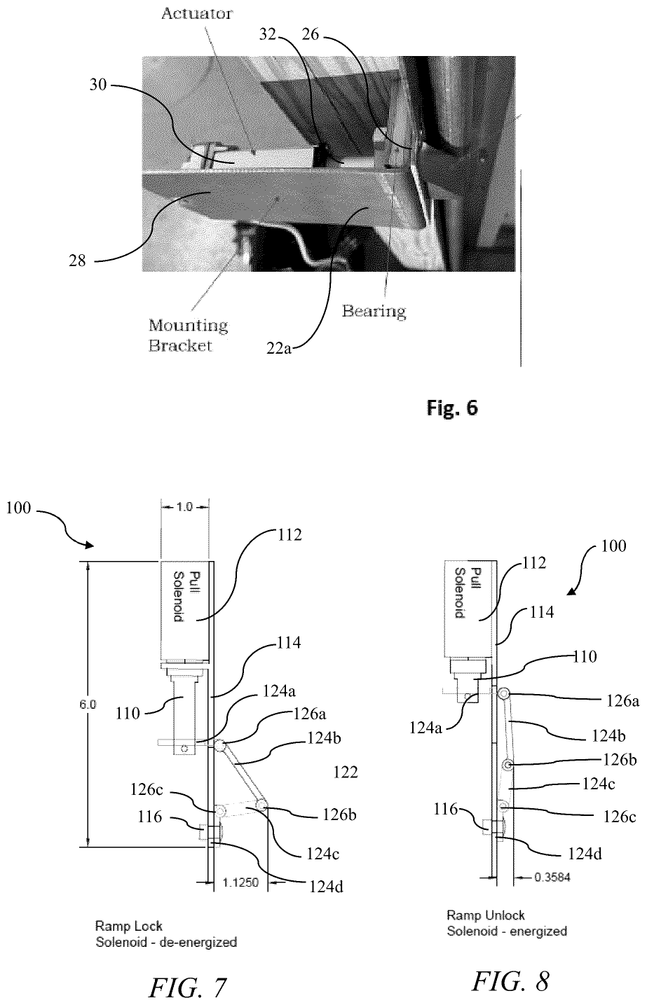

FIGS. 7 and 8 illustrate close-up views of a door-locking apparatus 100, in an alternate embodiment of the present invention. Specifically, the door-locking apparatus 100, as illustrated in FIG. 7, may comprise a linkage system 122 formed from a series of linkages 124a, 124b, 124c, 124d. Specifically, linkage 124a may be hingedly connected via hinge 126a to linkage 124b, whereas linkage 124b may be hingedly connected via hinge 126b to linkage 124c, and finally linkage 124c may be hingedly connected via hinge 126c to linkage 124d.

Linkage 124a may be connected to a shaft 110 of a solenoid 112 that may extend and retract the shaft 110 due to an electrical signal. Further, linkage 124d may be attached to a static surface 114, such as with a bolt, rivet, or other connector 116. The surface 114 may be a door track or other like surface associated with a roll-up or overhead door, as described above. FIG. 7 illustrates the shaft 110 in an extended position, which may push linkage 124a toward linkage 124d, causing the hinges 126a, 126b, 126c to rotate in a manner to cause the linkages 124a, 124b, 124c, 124d to form a ramp configuration when linkages 124b and 124c extend away from the surface 114. Such a ramp configuration may be used in the same manner as the ramps 22a, 22b, as described above with reference to FIGS. 1-6, interacting with a separate ramp (not shown) extending from the door and locking the door in a closed position. However, the ramp configuration of the linkage system 122 may be controlled via the solenoid 112 which may be disposed vertically and attached to a backside of the surface 114. This may allow the linkage system 122 and the control thereof via the solenoid 112 to be disposed in relatively small spaces.

FIG. 8 illustrates the linkage system 122 in a flat configuration when the shaft 110 of the solenoid 112 is retracted due to an electrical signal. When the shaft 110 retracts into the solenoid 112, the shaft 110 pulls linkage 124a away from linkage 124d, which is held on the surface via the connector 116. This may cause the linkages 124b, 124c to move toward the surface 114 thereby flattening the linkage system 122. Once in the flat configuration, the ramp (not shown) extending from the door (not shown) that had heretofore been locked against the ramp configuration of the linkage system 122 may be released and the door (not shown) may be moved.

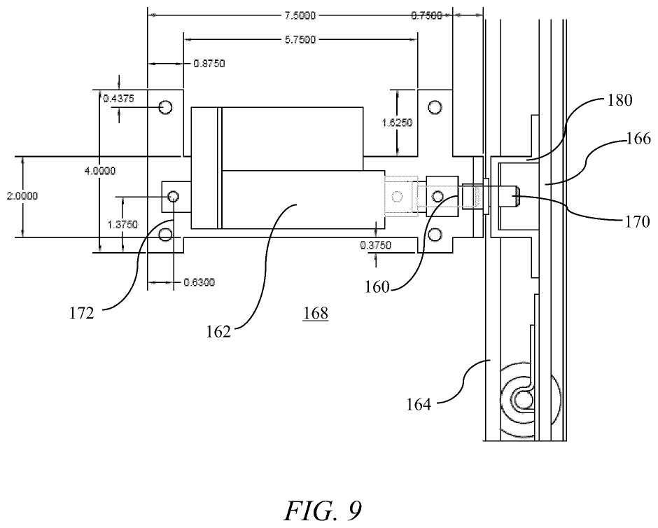

Referring now to FIG. 9, a close-up view of another door-locking system 150 is provided in an alternate embodiment of the present invention. Specifically, the door-locking system 150 may comprise a solenoid 162 that may be positioned so that the shaft 160 thereof may be disposed toward the track 164 of the door 166 with the solenoid 162 mounted on a side wall 168 of the vehicle. The shaft 160 of the solenoid 162 may have a pin 170 which may extend and retract, as illustrated in FIG. 9 based on the electrical signal received by the solenoid 162. The pin 170 may extend through an aperture of a bracket 180 that may be attached to the door 166 and extend toward an interior of the vehicle (not shown).

Therefore, when the shaft 160 of the solenoid 162 is extended, the pin 170 may extend through the aperture of the bracket 180 when the door 166 is in a closed position thereby holding the door in the closed position. When the shaft 160 of the solenoid 162 is retracted, the pin 170 may retract from the aperture of the bracket 180 and allow the door 166 to freely move.

The solenoid 162 may extend from the wall 168 of the vehicle via an extension base 172 that dispose the solenoid 162 a distance from the wall 168 so that the shaft 160 and pin 170 may engage the bracket 180 extending from the door 166.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A roll-up door locking system comprising:
a roll-up door configured to slide on a pair of tracks on opposite sides of the roll-up door between an open configuration and a closed configuration;
an actuator mounted adjacent at least one of the tracks, wherein the actuator comprises a piston having a contacting block on an end thereof, wherein the piston moves via the actuator between an extended position and a retracted position; and
an engagement element extending from the door, wherein the engagement element is configured to contact the ramp on the piston of the actuator.

2. The roll-up door locking system of claim 1 wherein the roll-up door slides on the pair of tracks via a plurality of rollers extending from the door and engaging the pair of tracks.

3. The roll-up door locking system of claim 1 wherein the actuator is an electrically controlled solenoid.

4. The roll-up door locking system of claim 1 wherein the actuator is controlled via a wireless signal.

5. The roll-up door locking system of claim 1 wherein the actuator selectively moves the contacting block when the actuator moves the piston between an extended position and a retracted position, wherein when the actuator is in the extended position, the contacting block is configured to contact the engagement element when the roll-up door is in the closed configuration.

6. The roll-up door locking system of claim 5 wherein when the actuator is in the retracted position, the contacting block is configured to be disengaged from the engagement element, allowing the roll-up door to move from the closed configuration to the open configuration.

7. The roll-up door locking system of claim 1 wherein the contacting block is a ramp.

8. The roll-up door locking system of claim 7 wherein the ramp has an angled face and a horizontal face, wherein the horizontal face is on an underside of the ramp.

9. The roll-up door locking system of claim 8 wherein the horizontal face of the ramp is configured to contact the engagement element and maintain the door in the closed configuration.

10. The roll-up door locking system of claim 1 wherein the contacting block is a pin.

11. The roll-up door locking system of claim 1 wherein the engagement element is selected from the group of a ramp, a block, and a bracket.

12. The roll-up door locking system of claim 1 wherein the engagement element is a ramp having a horizontal face and an angled face, wherein the horizontal face is on an upper side of the ramp.

13. The roll-up door locking system of claim 12 wherein the horizontal face of the ramp is configured to contact the contacting block when the door is in the closed configuration.

14. The roll-up door locking system of claim 1 wherein the engagement element is movable between an extended position and a retracted position.

15. The roll-up door locking system of claim 14 wherein the engagement element is biased toward the extended position.

16. The roll-up door locking system of claim 14 wherein the door has a handle and further wherein the handle is configured to move the engagement element between the extended position and the retracted position.

17. The roll-up door locking system of claim 1 wherein the actuator is mounted to a surface that is coplanar with the roll-up door when the roll-up door is in the closed configuration.

18. The roll-up door locking system of claim 1 wherein the actuator is mounted to a surface that is orthogonal to the roll-up door when the roll-up door is in the closed configuration.

19. The roll-up door locking system of claim 1 wherein the contacting block is formed from a plurality of linkages that are hinged together wherein extending the piston via the actuator forms a protruding configuration and further wherein retracting the piston via the actuator transforms the contacting block into a flat configuration.

20. The roll-up door locking system of claim 19 wherein the actuator is mounted to a surface coplanar with the roll-up door and the piston is configured to extend and retract vertically.
